(19) United States
(12) Patent Application Publication
(10) Pub. No.: US 2003/0163341 A1
(43) Pub. Date: Aug. 28, 2003

(54) Apparatus and method of dynamically updating dynamic host configuration protocol (DHCP) options

(75) Inventors: Dwip N. Banerjee, Austin, TX (US); Vasu Vallabhaneni, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/082,416

(22) Filed: Feb. 26, 2002

(51) Int. Cl. G06F 17/60

(52) U.S. Cl. 705/1

(57) ABSTRACT

A method, system and apparatus for dynamically updating dynamic host configuration protocol (DHCP) options are provided. A configuration file containing the options is stored in a DHCP server. The configuration file contains a sub-routine that periodically updates the options automatically. One of the options may be a router that client systems on the network are to use when transacting data. Another one of the options may be a domain name server that the client systems are to consult when converting domain name into IP addresses. In any event, each time the options are updated a different router and/or domain name server is used.

### BACKGROUND OF THE INVENTION

1. Technical Field

The present invention is directed to communications networks. More specifically, the present invention is directed to a method and apparatus for dynamically updating DHCP protocol.

2. Description of Related Art

DHCP is a protocol for assigning dynamic IP addresses to devices on a network. With dynamic addressing, a device can have a different IP address every time it connects to the network. In some systems, the device's IP address can even change while it is still connected. In any case, when a computer system (i.e., a client system) attaches itself to the network for the first time, it broadcasts a DHCPDISCOVER packet. A DHCP server on the local segment will see the broadcast and return a DHCPOFFER packet that contains an IP address and other information such as which router and domain name server to use. A router is a device that connects a plurality of LANs (local area networks) together. A domain name server is a computer system that contains a program that translates domain names into IP addresses. Domain name servers allow users to use domain names instead of IP addresses when communicating with other computer systems. An example of a domain name is: www.ibm.com.

The client system may receive multiple DHCPOFFER packets from any number of servers, so it must choose between them, and broadcast a DHCPREQUEST packet that identifies the explicit server and lease offer that it likes the best. A lease is the amount of time an IP address can be allocated to a client system. The decision regarding which lease offer to choose may be based on the offer that has the longest lease or provides the most information that the client system needs for optimal operation. If there are more client systems than IP addresses, using shorter leases can keep the server from running out of IP addresses. If there are more addresses than client systems, a permanent lease or a fixed IP address may be assigned to each client system.

In any event, the non-chosen servers would notice the explicit DHCPREQUEST packet and go on about their business. The chosen server would return a DHCPACK that tells the client system the lease is finalized. If the offer is no longer valid for any reason (e.g., due to a time-out or another client being allocated the lease), then the selected server must respond with a DHCPNAK message. This would cause the client system to send another DHCPDISCOVER packet, starting the process all over again.

Once the client system receives a DHCPACK, then all ownership and maintenance of the lease is the responsibility of the client. For example, a client system may refuse an offer that is detailed in the DHCPACK message, and it is the client's responsibility to do so. Client systems are supposed to test the addresses that have been offered to them by conducting an ARP (address resolution protocol) broadcast. If another node responds to the ARP broadcast, the client system should assume that the offered address is in use. At this point, the client system should reject the offer by sending a DHCPDECLINE message to the offering server, and should also send another DHCPDISCOVER packet, thereby starting the process yet again.

Once the client system has the lease, it must be renewed prior to the lease expiration through another DHCPREQUEST message. If a client system finishes using a lease prior to its expiration time, the client system is supposed to send a DHCPRELEASE message to the server so that the lease can be made available to other nodes. If the server does not hear from the client system by the end of the lease, it marks the lease as non-renewed, and makes it available for other client systems to use.

Thus, dynamic addressing simplifies network administration because the software keeps track of IP addresses rather than requiring an administrator to manage the task. This means that a new computer system can be added to a network without having to manually assign a unique IP address to the new system.

To assign IP addresses to the client systems, a DHCP server uses a configuration file in which is stored a range of IP addresses for each sub-network. This configuration file is used to build a database that is consulted whenever a DHCP server has to assign an IP address to a client system. Associated with each range of IP addresses are options for at least a router and a domain name server. Thus, when the DHCP server assigns an IP address from a particular range of addresses to a client system, it also specifies which router and domain name server the client should use. Hence, depending on the number of active client systems in a sub-network, there may be times when a particular router and/or domain name server is overburdened with network traffic. When that occurs, the system administrator may want to load-balance the network by associating a new router and/or domain name server with the range of IP addresses. To do so, the system administrator has to modify the configuration file.

As is well known in the industry, each time a configuration file is modified, the DHCP server has to be refreshed. Obviously, while the DHCP server is being refreshed, it cannot respond to any IP address requests. In addition, while client systems that have requested IP addresses after the DHCP server has been refreshed will use an unburdened router and/or domain name server, the ones that were assigned IP addresses before the DHCP server was refreshed will continue to use the overburdened router and/or domain name server.

Thus, what is needed is a method and apparatus for dynamically load-balancing routers and/or domain name servers in a network.

### SUMMARY OF THE INVENTION

The present invention provides a method, system and apparatus for dynamically updating dynamic host configuration protocol (DHCP) options. A configuration file containing the options is stored on a DHCP server. The configuration file contains a stanza containing the dynamic options. The stanza also contains the frequency at which the options are to be updated. One of the options may be a router that client systems on the network are to use when transacting data. Another one of the options may be a domain name server that the client systems are to consult when converting domain name into IP addresses. In any event, each time the options are updated a different router and/or domain name server is used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 represents a mapping table in which a router and a domain name server are associated with a range of IP addresses.

FIG. 5 depicts a modified mapping table of FIG. 4.

FIG. 6 FIG. 6 illustrates the sub-routine used by the present invention.

### DETAILED DESCRIPTION OF THE PREFERRED EMBODIMENT

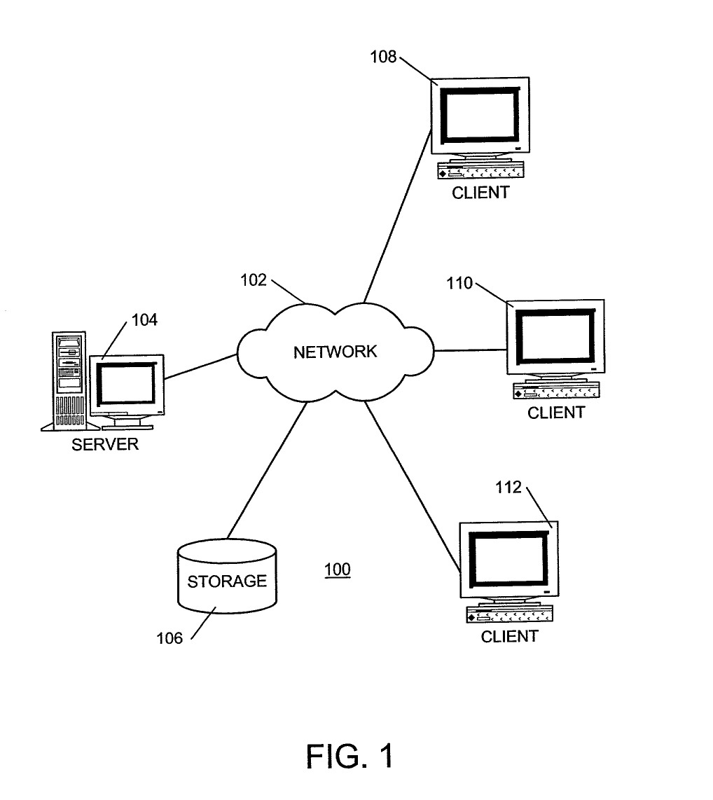

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

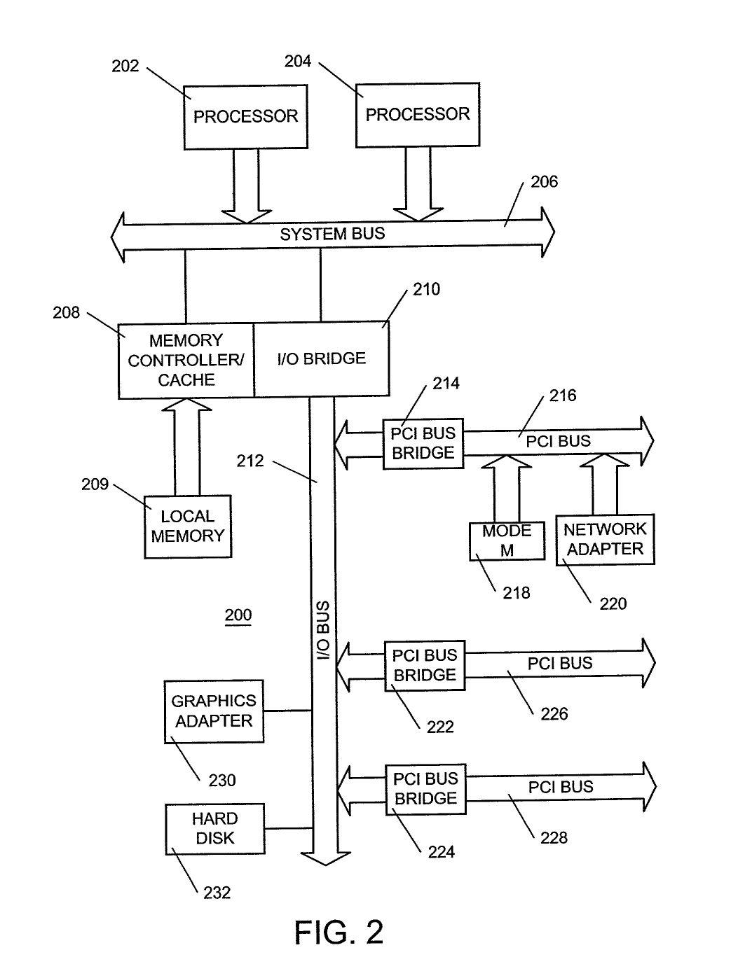

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, New York, running the Advanced Interactive Executive (AIX) operating system or LINUX operating system.

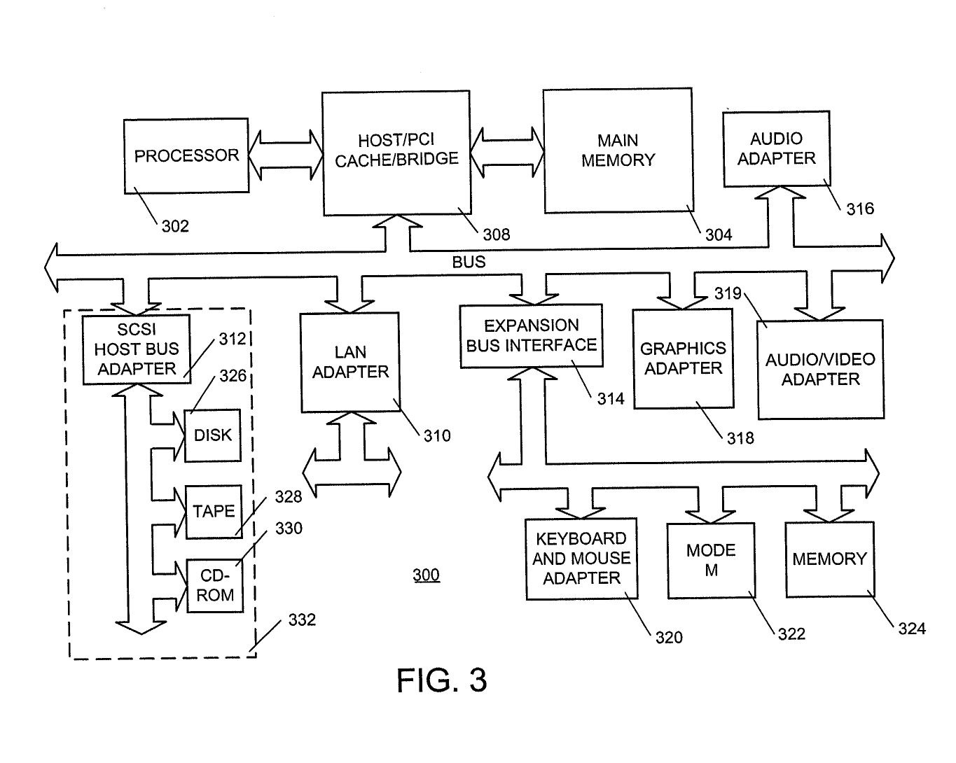

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of dynamically load-balancing routers and/or domain name servers in a network. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

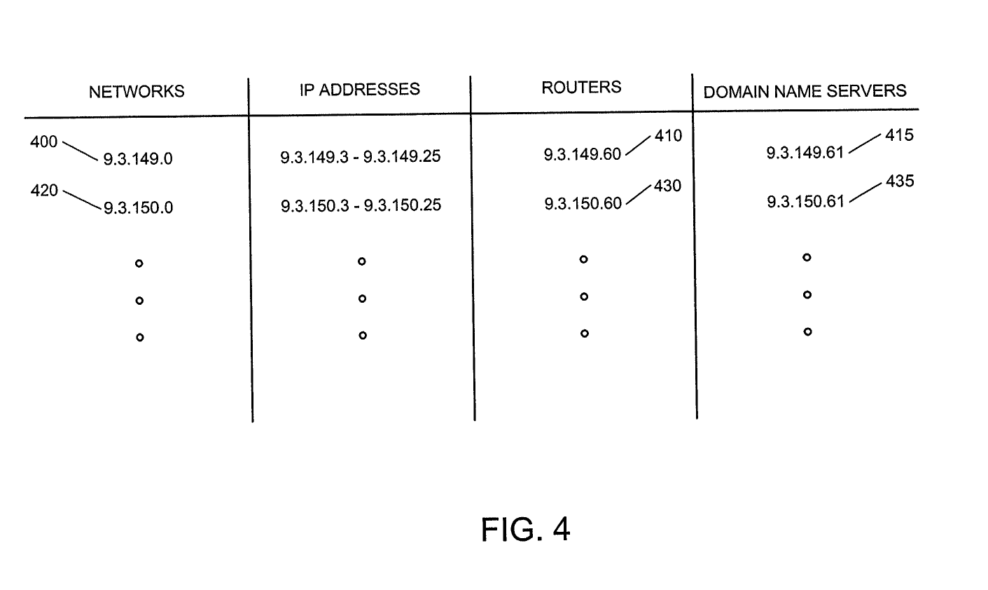

FIG. 4 represents a mapping table in which a router and a domain name server are associated with a range of IP addresses. Note that although twenty-three (23) IP addresses are displayed for each network (e.g., 9.3.149.3 to 9.3.149.25, inclusively in network, 400), in actuality, there may be many more IP addresses in each range. In accordance with the mapping table, when a client system from network₁ 400 (e.g., IP address 9.3.149.0) requests an IP address from the DHCP server, the DHCP server will offer an IP address from the range of IP addresses 9.3.149.3 to 9.3.149.25. Along with the IP address, the DHCP server will pass router, 410 (i.e., 9.3.149.60) and domain name server, 415 (i.e., 9.3.149.61) as the router and domain name server that the client system ought to use.

If another client system from network, 400 requests an IP address, the DHCP server will offer an IP address from the same range of IP addresses 9.3.149.3 to 9.3.149.25, excluding, of course, the IP address assigned to the previous client system. Again router, 410 (i.e., 9.3.149.60) and domain name server, 415 (i.e., 9.3.149.61) will be passed to the client system as the router and domain name server to use.

Based on the mapping table in FIG. 4, twenty-three (23) client systems may be assigned each an IP address from the range of IP addresses 9.3.149.3 to 9.3.149.25. However, all twenty-three (23) client systems will use the same router₁ 410 and domain name server₁ 415. Likewise, twenty-three (23) client systems from network₂ 420 (9.3.150.0) may be assigned each an IP address from the range of IP addresses 9.3.150.3 to 9.3.150.25. But just like in network, 400, all twenty-three (23) client systems will use the same router₁ 430 and domain name server₁ 435.

If router, 410 and/or domain name server, 415 becomes overburdened with network traffic (this may manifest itself by an inordinate amount of time taken to transact data between a client on network, and another computer system), the administrator may decide to use another router and/or domain name server. As mentioned before, to do so, the administrator has to modify the table and then refresh the DHCP server after making the appropriate changes into the configuration file.

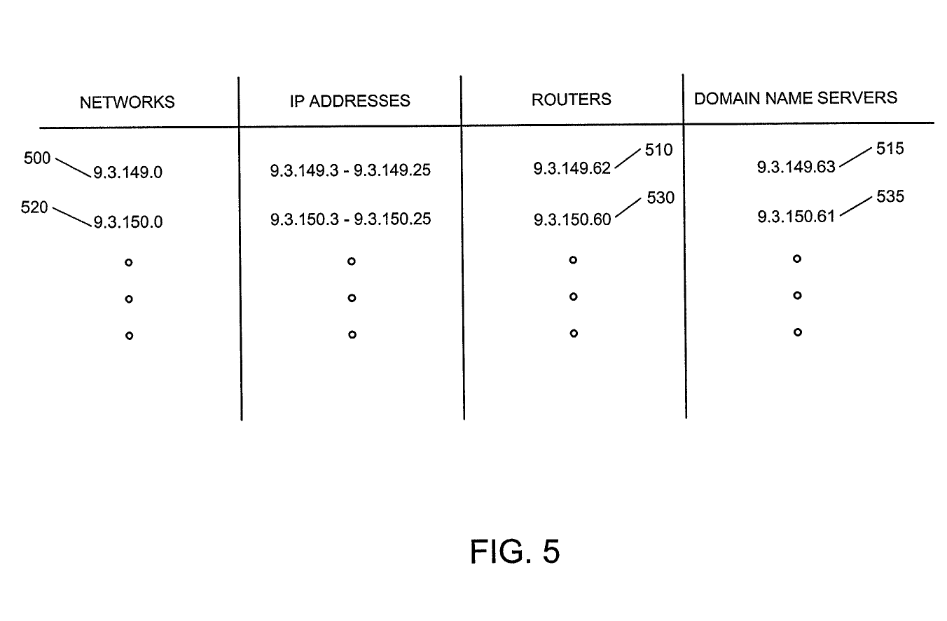

FIG. 5 depicts a modified mapping table of FIG. 4. As shown, after the DHCP is refreshed, it will direct any new client on network, that requests an IP address to use router₁₂ 510 (i.e., 9.3.149.62) as well as domain name server₁₂ (9.3.149.63) instead of router, 410 (9.3.149.60) and domain name server₁ 415 (9.3.149.61). However, any client on network, that was previously directed to use the overburdened router₁ and domain name server₁ will continue to do so. In any case, the process of modifying the configuration file and refreshing the DHCP server after each modification is not an ideal solution as it is very difficult to predict when a particular router or name server or any server will get overloaded. An ideal solution is to automate the whole process and thus; circumventing such a process. The present invention provides a method of doing so.

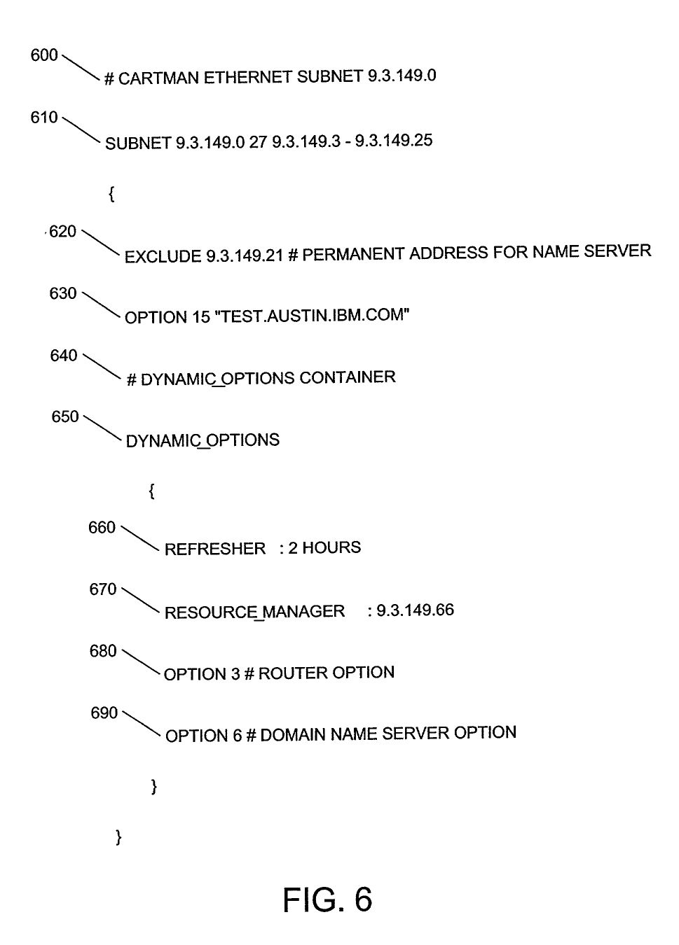

FIG. 6 illustrates a new dynamic option stanza that may be used in a configuration file. Line 600 is a comment documenting the stanza. For example, CARTMAN is the name of the network and the network IP address is 9.3.149.0. Line 610 specifies the sub-network keyword (i.e., IP address 9.3.149.0), the network mask is 27 and the IP addresses that should be assigned to a client system on the network should be from 9.3.149.3 to 9.3.149.25, inclusively. Out of the range of IP addresses, IP address 9.3.149.21 should be excluded since it is the permanent IP address of a domain name server (see line 620). Option 15 from line 630 identifies a domain name. Line 640 is a comment identifying the dynamic option container. The dynamic option stanza (see line 650) calls for a refresh every two (2) hours by checking a resource manager (line 670) having 9.3.149.66 as an IP address in order to get a new router (option 3 on line 680) and a new domain name server (option 6 on line 690). The resource manager may be a server that contains a list of all resources including routers and domain name servers that may be used within the sub-network. Alternatively, the resource manager may be running on the same machine as the the DHCP server. In that case, an IP address need not be supplied on line 670.

Consequently, every two (2) hours, the DHCP server will contact the resource manager (or a load manager) and obtain a new router and domain name server to supply to client systems requesting IP addresses. Note that in this case a two-hour update time interval is used. However, it may not be ideal for the network. Thus, the system administrator may need to figure out a suitable update time interval. Once a suitable update time interval is found, it may be inputted into the stanza. From that time on, The DHCP server will obtain a different value for options 3 and 6 from the resource manager or load manager dynamically. Hence, the DHCP server will continuously pass a different router and domain name server to requesting client systems in the network as per the refresh time interval.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of dynamically updating dynamic host configuration protocol, (DHCP) options stored on a computer system comprising the steps of:
setting up the options into a configuration file; and
periodically updating the options automatically.

2. The method of claim 1 wherein the options are passed to a client system requesting an IP address.

3. The method of claim 2 wherein one of the options is a router that the requesting client system is to use when communicating on a network.

4. The method of claim 3 wherein another one of the options is a domain name server that the requesting client system is to use to convert domain names of computer systems into IP addresses.

5. A method of load-balancing network data traffic on network resources comprising the steps of:
setting up at least one option to use at least one of the network resources into a configuration file, the configuration file being stored on a computer system; and
periodically updating the at least one option automatically to use another one of the resources.

6. The method of claim 5 wherein the configuration file is stored on a dynamic host configuration protocol (DHCP) server.

7. The method of claim 6 wherein the at least one option is a router.

8. The method of claim 6 wherein the at least one option is a domain name server used to convert domain names of computer systems into IP addresses.

9. A computer program product on a computer readable medium for dynamically updating dynamic host configuration protocol (DHCP) options stored on a computer system comprising:
code means for setting up the options into a configuration file; and
code means for periodically updating the options automatically.

10. The computer program product of claim 9 wherein the options are passed to a client system requesting an IP address.

11. The computer program product of claim 10 wherein one of the options is a router that the requesting client system is to use when communicating on a network.

12. The computer program product of claim 11 wherein another one of the options is a domain name server that the requesting client system is to use to convert domain names of computer systems into IP addresses.

13. A computer program product on a computer readable medium for load-balancing network data traffic on network resources comprising:
code means for setting up at least one option to use at least one of the network resources, the at least one option being in a configuration file stored stored on a computer system; and
code means for periodically updating the at least one option automatically to use another one of the resources.

14. The computer program product of claim 13 wherein the configuration file is stored on a dynamic host configuration protocol (DHCP) server.

15. The computer program product of claim 14 wherein the at least one option is a router.

16. The computer program product of claim 14 wherein the at least one option is a domain name server used to convert domain names of computer systems into IP addresses.

17. An apparatus for dynamically updating dynamic host configuration protocol (DHCP) options stored on a computer system comprising:
means for setting up the options into a configuration file; and
means for periodically updating the options automatically.

18. The apparatus of claim 17 wherein the options are passed to a client system requesting an IP address.

19. The apparatus of claim 18 wherein one of the options is a router that the requesting client system is to use when communicating on a network.

20. The apparatus of claim 19 wherein another one of the options is a domain name server that the requesting client system is to use to convert domain names of computer systems into IP addresses.

21. An apparatus for load-balancing network data traffic on network resources comprising:
means for setting up at least one option to use at least one of the network resources into a configuration file, the configuration file being stored on a computer system; and
means for periodically updating the at least one option automatically to use another one of the resources.

22. The apparatus of claim 21 wherein the configuration file is stored on a dynamic host configuration protocol (DHCP) server.

23. The apparatus of claim 22 wherein the at least one option is a router.

24. The apparatus of claim 22 wherein the at least one option is a domain name server used to convert domain names of computer systems into IP addresses.

25. A computer system for dynamically updating dynamic host configuration protocol (DHCP) options comprising:
at least one storage device to store code data; and
at least one processor for processing said code data to set up the options into a configuration file, and to periodically update the options automatically.

26. The computer system of claim 25 wherein the options are passed to a client system requesting an IP address.

27. The computer system of claim 26 wherein one of the options is a router that the requesting client system is to use when communicating on a network.

28. The computer system of claim 27 wherein another one of the options is a domain name server that the requesting client system is to use to convert domain names of computer systems into IP addresses.

29. A computer system for load-balancing network data traffic on network resources comprising:
at least one storage device to store code data; and
at least one processor to process said code data to set up at least one option to use at least one of the network resources into a configuration file, the configuration file being stored on a computer system, and to periodically update the at least one option automatically to use another one of the resources, the at least one option being passed to a computer system using the network.

30. The computer system of claim 29 wherein the configuration file is stored on a dynamic host configuration protocol (DHCP) server.

31. The computer system of claim 30 wherein the at least one option is a router.

32. The computer system of claim 30 wherein the at least one option is a domain name server used to convert domain names of computer systems into IP addresses.
